(19) United States
(12) Patent Application Publication
(10) Pub. No.: US 2026/0110769 A1
(43) Pub. Date: Apr. 23, 2026

(54) UE ASSISTED RADAR PROCESSING

(71) Applicant: Google LLC, Mountain View, CA (US)

(72) Inventors: Jibing Wang, San Jose, CA (US); Erik Richard Stauffer, Mountain View, CA (US)

(21) Appl. No.: 19/117,620

(22) PCT Filed: Oct. 25, 2023
(86) PCT No.: PCT/US2023/077710

§ 371 Date: Apr. 1, 2025

Related U.S. Application Data
(60) Provisional application No. 63/381,494, filed on Oct. 28, 2022.

(51) Int. Cl. G01S 7/00; G01S 13/00

(52) U.S. Cl. CPC G01S 7/006; G01S 13/003

(57) ABSTRACT

This disclosure provides systems, devices, apparatus, and methods, including computer programs encoded on storage media, for bistatic radar assistance sensing. A radar-receiver receives (210), from a radar-transmitter, a configuration message that configures the radar-receiver to assist the radar-transmitter with bistatic radar sensing. The radar-receiver receives (214) a reflection of the radar signal. Responsive to the receiving the reflection of the radar signal, the radar-receiver transmits (218), to the radar-transmitter, a radar measurement report message. The radar-receiver receives (202), from the radar-transmitter, a radar capability enquiry. The radar-eceiver transmits (204), to the radar-transmitter in response to the radar capability enquiry, a radar capability response that indicates radar capabilities supported by the radar-receiver for the bistatic radar sensing.

### CROSS-REFERENCE TO RELATED APPLICATIONS

This application claims the benefit of U.S. Provisional Patent Application No. US63/381,494, filed 28 Oct. 2022 the disclosure of which is incorporated herein by reference in its entirety.

### TECHNICAL FIELD

The present disclosure relates generally to wireless communication, and more particularly, to systems and methods of radar signal processing.

### BACKGROUND

The Third Generation Partnership Project (3GPP) specifies a radio interface referred to as fifth generation (5G) new radio (NR) (5G NR). An architecture for a 5G NR wireless communication system can include a 5G core (5GC) network, a 5G radio access network (5G-RAN), a user equipment (UE), etc. The 5G NR architecture might provide increased data rates, decreased latency, and/or increased capacity compared to other types of wireless communication systems.

Wireless communication systems, in general, may be configured to provide various telecommunication services (e.g., telephony, video, data, messaging, broadcasts, etc.) based on multiple-access technologies, such as orthogonal frequency division multiple access (OFDMA) technologies, that support communication with multiple UEs. Improvements in mobile broadband, such as the integration of radar technologies with mobile broadband technologies, have been useful to continue the progression of such wireless communication technologies. Challenges, however, to implementing radar in a communications system include self-interference cancelation in monostatic systems, which might result in loss of communication information in situations when transmitted and received signals carry both radar and communication information.

### SUMMARY

The following presents a simplified summary to provide a basic understanding of aspects of the disclosure. This summary is not an extensive overview of all contemplated aspects. Instead, this summary is a prelude to the more detailed description below.

Conventional techniques for object detection using monostatic radar configurations that employ full-duplex operations may result in high self-interference from the radar-transmitters to the radar-receivers (e.g., within a same radar transceiver). High self-interference can degrade full-duplex operations and negatively impact radar sensing accuracy.

The present disclosure addresses the above-noted and other deficiencies, in a first example, by using a user equipment (UE) as a radar-receiver and a network entity as a radar-transmitter to perform bistatic radar sensing. For example, the network entity can perform the bistatic radar sensing with assistance from the UE. To perform the bistatic radar sensing with the assistance of the UE, the network entity configures the UE based on a radar capability of the UE using a radar assistance configuration message. The network entity transmits, to the UE, the radar assistance configuration message to assist the network entity with the bistatic radar sensing. The network entity transmits a radar signal which reflects from an object to the UE. The network entity may add downlink communication information to the radar signal to result in a combined radar and communication signal. The UE can demodulate and decode the communication portion of the received combined radar and communication signal. The network entity receives, from the UE, a radar measurement report message including radar information for the object.

Alternatively or additionally, the UE can be configured as the radar-transmitter and the network entity can be configured as the radar-receiver. In this example, the UE requests the network entity to assist the UE with performing bistatic radar sensing. For example, if the UE can perform functionalities of a radar-transmitter, the UE may query whether the network entity can perform functionalities of a radar-receiver. The network entity transmits to the UE radar receiver capability information. That is, the network entity transmits a first acknowledgement message if the network entity can assist the UE, and transmits a second acknowledgement message if the network entity cannot assist the UE. The UE transmits a radar signal that reflects off an object to the network entity. The UE may add uplink communication information to the radar signal to result in a combined radar and communication signal. The BS can demodulate and decode the communication portion of the received combined radar and communication signal. The network entity performs radar processing and transmits to the UE a radar measurement report message including radar information for the object.

Accordingly, the UE and/or the network entity performing the bistatic radar sensing can overcome the limitations associated with conventional monostatic object detection techniques. The UE and/or the network entity performing the bistatic radar sensing can reduce high self-interference caused by the radar-transmitter to the radar-receiver that might contribute to degraded full-duplex system performance.

Another example includes a base station (BS) or UE with hardware configured to implement the above-described method.

### BRIEF DESCRIPTION OF THE DRAWINGS

FIG. 1A illustrates a diagram of a wireless communications system that includes a plurality of user equipments (UEs) and network entities in communication over one or more cells.

FIGS. 1B-1C are diagrams illustrating example environments for implementing user equipment (UE) assisted radar processing, according to some embodiments.

FIG. 2 is a signaling diagram that illustrates procedures for radar sensing assistance with a network entity as a radar-transmitter, according to some embodiments.

FIG. 3 is a signaling diagram that illustrates procedures for radar sensing assistance with a UE as a radar-transmitter, according to some embodiments.

FIG. 4 is a flowchart of a method of radar sensing assistance at a radar-transmitter, according to some embodiments.

FIG. 5 is a flowchart of a method of radar sensing assistance at a radar-receiver, according to some embodiments.

FIG. 6 is a block diagram illustrating an example of a hardware implementation for an example UE apparatus.

FIG. 7 is a diagram illustrating an example of a hardware implementation for one or more example network entities.

### DETAILED DESCRIPTION

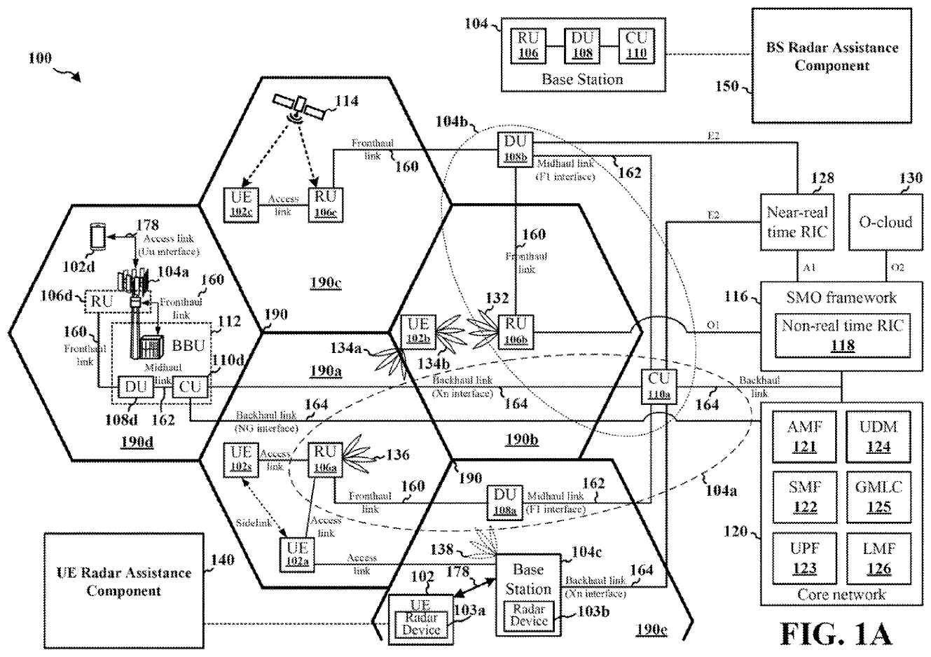

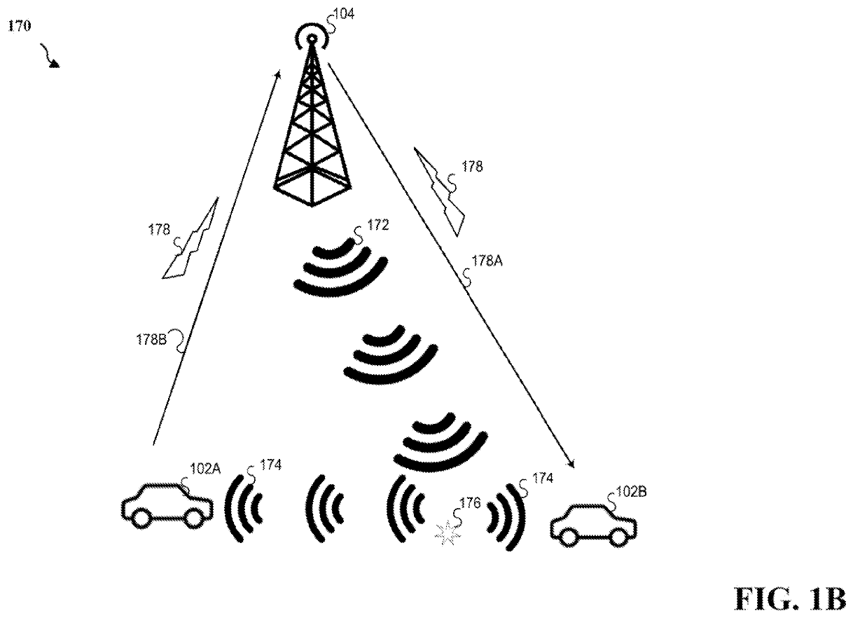

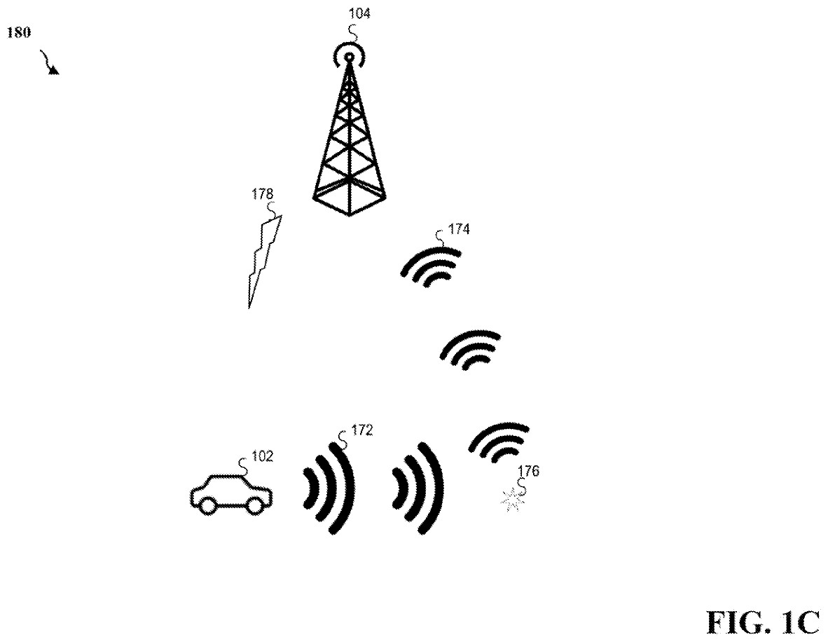

FIG. 1A illustrates a diagram 100 of a wireless communications system associated with a plurality of cells 190. The wireless communications system includes user equipments (UEs) 102 and base stations 104, where some base stations 104c include an aggregated base station architecture and other base stations 104a-104b include a disaggregated base station architecture. The UEs 102 may include a radar device 103a and the base stations 104c may include a radar device 103b. The UEs 102 may communicate with the base stations 104c via one or more radio frequency (RF) access links 178. The aggregated base station architecture includes a radio unit (RU) 106, a distributed unit (DU) 108, and a centralized unit (CU) 110 that are configured to utilize a radio protocol stack that is physically or logically integrated within a single radio access network (RAN) node. A disaggregated base station architecture utilizes a protocol stack that is physically or logically distributed among two or more units (e.g., RUs 106, DUs 108, CUs 110). For example, a CU 110 is implemented within a RAN node, and one or more DUs 108 may be co-located with the CU 110, or alternatively, may be geographically or virtually distributed throughout one or multiple other RAN nodes. The DUs 108 may be implemented to communicate with one or more RUs 106. Each of the RU 106, the DU 108 and the CU 110 can be implemented as virtual units, such as a virtual radio unit (VRU), a virtual distributed unit (VDU), or a virtual central unit (VCU). A base station 104 and/or a unit of the base station 104, such as the RU 106, the DU 108, or the CU 110, may be referred to as a transmission reception point (TRP).

Operations of the base stations 104 and/or network designs may be based on aggregation characteristics of base station functionality. For example, disaggregated base station architectures are utilized in an integrated access backhaul (IAB) network, an open-radio access network (O-RAN) network, or a virtualized radio access network (vRAN) which may also be referred to a cloud radio access network (C-RAN). Disaggregation may include distributing functionality across the two or more units at various physical locations, as well as distributing functionality for at least one unit virtually, which can enable flexibility in network designs. The various units of the disaggregated base station architecture, or the disaggregated RAN architecture, can be configured for wired or wireless communication with at least one other unit. For example, the CU 110a communicates with the DUs 108a-108b via respective midhaul links 162 based on F1 interfaces. The DUs 108a-108b may respectively communicate with the RU 106a and the RUS 106b-106c via respective fronthaul links 160. The RUs 106a-106c may communicate with respective UEs 102a-102c and 102s via one or more radio frequency (RF) access links 178 based on a Uu interface. In examples, multiple RUs 106 and/or base stations 104 may simultaneously serve the UEs 102, such as the UE 102a of the cell 190a that the access links 178 for the RU 106a of the cell 190a and the base station 104c of the cell 190e simultaneously serve.

One or more CUs 110, such as the CU 110a or the CU 110d, may communicate directly with a core network 120 via a backhaul link 164. For example, the CU 110d communicates with the core network 120 over a backhaul link 164 based on a next generation (NG) interface. The one or more CUs 110 may also communicate indirectly with the core network 120 through one or more disaggregated base station units, such as a near-real time RAN intelligent controller (RIC) 128 via an E2 link and a service management and orchestration (SMO) framework 116, which may be associated with a non-real time RIC 118. The near-real time RIC 128 might communicate with the SMO framework 116 and/or the non-real time RIC 118 via an A1 link. The SMO framework 116 and/or the non-real time RIC 118 might also communicate with an open cloud (O-4-cloud) 130 via an O2 link. The one or more CUs 110 may further communicate with each other over a backhaul link 164 based on an Xn interface. For example, the CU 110d of the base station 104c communicates with the CU 110a of the base station 104b over the backhaul link 164 based on the Xn interface. Similarly, the base station 104c of the cell 190e may communicate with the CU 110a of the base station 104b over a backhaul link 164 based on the Xn interface.

The RUs 106, the DUs 108, and the CUS 110, as well as the near-real time RIC 128, the non-real time RIC 118, and/or the SMO framework 116, may include (or may be coupled to) one or more interfaces configured to transmit or receive information/signals via a wired or wireless transmission medium. A base station 104 or any of the one or more disaggregated base station units can be configured to communicate with one or more other base stations 104 or one or more other disaggregated base station units via the wired or wireless transmission medium. In examples, a processor, a memory, and/or a controller associated with executable instructions for the interfaces can be configured to provide communication between the base stations 104 and/or the one or more disaggregated base station units via the wired or wireless transmission medium. For example, a wired interface can be configured to transmit or receive the information/signals over a wired transmission medium, such as for the fronthaul link 160 between the RU 106d and the baseband unit (BBU) 112 of the cell 190d or, more specifically, the fronthaul link 160 between the RU 106d and DU 108d. The BBU 112 includes the DU 108d and a CU 110d, which may also have a wired interface configured between the DU 108d and the CU 110d to transmit or receive the information/signals between the DU 108d and the CU 110d based on a midhaul link 162. In further examples, a wireless interface, which may include a receiver, a transmitter, or a transceiver (such as an RF transceiver), can be configured to transmit or receive the information/signals via the wireless transmission medium, such as for information communicated between the RU 106a of the cell 190a and the base station 104c of the cell 190e via cross-cell communication beams of the RU 106a and the base station 104c.

One or more higher layer control functions, such as function related to radio resource control (RRC), packet data convergence protocol (PDCP), service data adaptation protocol (SDAP), and the like, may be hosted at the CU 110. Each control function may be associated with an interface for communicating signals based on one or more other control functions hosted at the CU 110. User plane functionality such as central unit-user plane (CU-UP) functionality, control plane functionality such as central unit-control plane (CU-CP) functionality, or a combination thereof may be implemented based on the CU 110. For example, the CU 110 can include a logical split between one or more CU-UP procedures and/or one or more CU-CP procedures. The CU-UP functionality may be based on bidirectional communication with the CU-CP functionality via an interface, such as an El interface (not shown), when implemented in an O-RAN configuration.

The CU 110 may communicate with the DU 108 for network control and signaling. The DU 108 is a logical unit of the base station 104 configured to perform one or more base station functionalities. For example, the DU 108 can control the operations of one or more RUs 106. One or more of a radio link control (RLC) layer, a medium access control (MAC) layer, or one or more higher physical (PHY) layers, such as forward error correction (FEC) modules for encoding/decoding, scrambling, modulation/demodulation, or the like can be hosted at the DU 108. The DU 108 may host such functionalities based on a functional split of the DU 108. The DU 108 may similarly host one or more lower PHY layers, where each lower layer or module may be implemented based on an interface for communications with other layers and modules hosted at the DU 108, or based on control functions hosted at the CU 110.

The RUs 106 may be configured to implement lower layer functionality. For example, the RU 106 is controlled by the DU 108 and may correspond to a logical node that hosts RF processing functions, or lower layer PHY functionality, such as execution of fast Fourier transform (FFT), inverse FFT (iFFT), digital beamforming, physical random access channel (PRACH) extraction and filtering, etc. The functionality of the RUs 106 may be based on the functional split, such as a functional split of lower layers.

The RUs 106 may transmit or receive over-the-air (OTA) communication with one or more UEs 102. For example, the RU 106b of the cell 190b communicates with the UE 102b of the cell 190b via a first set of communication beams 132 of the RU 106b and a second set of communication beams 134b of the UE 102b, which may correspond to inter-cell communication beams or cross-cell communication beams. For example, the UE 102b of the cell 190b may communicate with the RU 106a of the cell 190a via a third set of communication beams 134a of the UE 102b and an RU beam set 136 of the RU 106a. Both real-time and non-real-time features of control plane and user plane communications of the RUs 106 can be controlled by associated DUs 108. Accordingly, the DUs 108 and the CUS 110 can be utilized in a cloud-based RAN architecture, such as a vRAN architecture, whereas the SMO framework 116 can be utilized to support non-virtualized and virtualized RAN network elements. For non-virtualized network elements, the SMO framework 116 may support deployment of dedicated physical resources for RAN coverage, where the dedicated physical resources may be managed through an operations and maintenance interface, such as an O1 interface. For virtualized network elements, the SMO Framework 116 may interact with a cloud computing platform, such as the O-cloud 130 via the O2 link (e.g., cloud computing platform interface), to manage the network elements. Virtualized network elements can include, but are not limited to, RUs 106, DUs 108, CUs 110, near-real time RICs 128, etc.

The SMO framework 116 may be configured to utilize an O1 link to communicate directly with one or more RUs 106. The non-real time RIC 118 of the SMO framework 116 may also be configured to support functionalities of the SMO framework 116. For example, the non-real time RIC 118 implements logical functionality that enables control of non-real time RAN features and resources, features/applications of the near-real time RIC 128, and/or artificial intelligence/machine learning (AI/ML) procedures. The non-real time RIC 118 may communicate with (or be coupled to) the near-real time RIC 128, such as through the A1 interface. The near-real time RIC 128 may implement logical functionality that enables control of near-real time RAN features and resources based on data collection and interactions over an E2 interface, such as the E2 interfaces between the near-real time RIC 128 and the CU 110a and the DU 108b.

The non-real time RIC 118 may receive parameters or other information from external servers to generate AI/ML models for deployment in the near-real time RIC 128. For example, the non-real time RIC 118 receives the parameters or other information from the O-cloud 130 via the O2 link for deployment of the AI/ML models to the real-time RIC 128 via the A1 link. The near-real time RIC 128 may utilize the parameters and/or other information received from the non-real time RIC 118 or the SMO framework 116 via the A1 link to perform near-real time functionalities. The near-real time RIC 128 and the non-real time RIC 118 may be configured to adjust a performance of the RAN. For example, the non-real time RIC 118 monitors patterns and long-term trends to increase the performance of the RAN. The non-real time RIC 118 may also deploy AI/ML models for implementing corrective actions through the SMO framework 116, such as initiating a reconfiguration of the O1 link or indicating management procedures for the A1 link.

Any combination of the RU 106, the DU 108, and the CU 110, or reference thereto individually, may correspond to a base station 104. Thus, the base station 104 may include at least one of the RU 106, the DU 108, or the CU 110. The base stations 104 provide the UEs 102 with access to the core network 120. That is, the base stations 104 might relay communications between the UEs 102 and the core network 120. The base stations 104 may be associated with macrocells for high-power cellular base stations and/or small cells for low-power cellular base stations. For example, the cell 190e corresponds to a macrocell, whereas the cells 190a-190d may correspond to small cells. Small cells include femtocells, picocells, microcells, etc. A cell structure that includes at least one macrocell and at least one small cell may be referred to as a “heterogeneous network.”

Transmissions from a UE 102 to a base station 104/RU 106 are referred to uplink (UL) transmissions, whereas transmissions from the base station 104/RU 106 to the UE 102 are referred to as downlink (DL) transmissions. Uplink transmissions may also be referred to as reverse link transmissions and downlink transmissions may also be referred to as forward link transmissions. For example, the RU 106d utilizes antennas of the base station 104c of cell 190d to transmit a downlink/forward link communication to the UE 102d or receive an uplink/reverse link communication from the UE 102d based on the Uu interface associated with the access link 178 between the UE 102d and the base station 104c/RU 106d.

Communication links between the UEs 102 and the base stations 104/RUs 106 may be based on multiple-input and multiple-output (MIMO) antenna technology, including spatial multiplexing, beamforming, and/or transmit diversity. The communication links may be associated with one or more carriers. The UEs 102 and the base stations 104/RUs 106 may utilize a spectrum bandwidth of Y MHz (e.g., 5, 10, 15, 20, 100, 400, 800, 1600, 2000, etc. MHz) per carrier allocated in a carrier aggregation of up to a total of Yx MHz, where x component carriers (CCs) are used for communication in each of the uplink and downlink directions. The carriers may or may not be adjacent to each other along a frequency spectrum. In examples, uplink and downlink carriers may be allocated in an asymmetric manner, more or fewer carriers may be allocated to either the uplink or the downlink. A primary component carrier and one or more secondary component carriers may be included in the component carriers. The primary component carrier may be associated with a primary cell (PCell) and a secondary component carrier may be associated with as a secondary cell (SCell).

Some UEs 102, such as the UEs 102a and 102s, may perform device-to-device (D2D) communications over sidelink. For example, a sidelink communication/D2D link utilizes a spectrum for a wireless wide area network (WWAN) associated with uplink and downlink communications. The sidelink communication/D2D link may also use one or more sidelink channels, such as a physical sidelink broadcast channel (PSBCH), a physical sidelink discovery channel (PSDCH), a physical sidelink shared channel (PSSCH), and/or a physical sidelink control channel (PSCCH), to communicate information between UEs 102a and 102s. Such sidelink/D2D communication may be performed through various wireless communications systems, such as wireless fidelity (Wi-Fi) systems, Bluetooth systems, Long Term Evolution (LTE) systems, New Radio (NR) systems, etc.

The electromagnetic spectrum is often subdivided into different classes, bands, channels, etc., based on different frequencies/wavelengths associated with the electromagnetic spectrum. Fifth-generation (5G) NR is generally associated with two operating frequency ranges (FRs) referred to as frequency range 1 (FR1) and frequency range 2 (FR2). FR1 ranges from 410 MHz-7.125 GHz and FR2 ranges from 24.25 GHz-71.0 GHz, which includes FR2-1 (24.25 GHz-52.6 GHZ) and FR2-2 (52.6 GHZ-71.0 GHZ). Although a portion of FR1 is actually greater than 6 GHz, FRI is often referred to as the “sub-6 GHz” band. In contrast, FR2 is often referred to as the “millimeter wave” (mmW) band. FR2 is different from, but a near subset of, the “extremely high frequency” (EHF) band, which ranges from 30 GHz-300 GHz and is sometimes also referred to as a “millimeter wave” band. Frequencies between FR1 and FR2 are often referred to as “mid-band” frequencies. The operating band for the mid-band frequencies may be referred to as frequency range 3 (FR3), which ranges 7.125 GHz-24.25 GHz. Frequency bands within FR3 may include characteristics of FR1 and/or FR2. Hence, features of FR1 and/or FR2 may be extended into the mid-band frequencies. Higher operating frequency bands have been identified to extend 5G NR communications above 52.6 GHz associated with the upper limit of FR2. Three of these higher operating frequency bands include FR2-2, which ranges from 52.6 GHz-71.0 GHz, FR4, which ranges from 71.0 GHz-114.25 GHz, and FR5, which ranges from 114.25 GHZ-300 GHz. The upper limit of FR5 corresponds to the upper limit of the EHF band. Thus, unless otherwise specifically stated herein, the term “sub-6 GHz” may refer to frequencies that are less than 6 GHZ, within FR1, or may include the mid-band frequencies. Further, unless otherwise specifically stated herein, the term “millimeter wave”, or mmW, refers to frequencies that may include the mid-band frequencies, may be within FR2-1, FR4, FR2-2, and/or FR5, or may be within the EHF band.

The UEs 102 and the base stations 104/RUs 106 may each include a plurality of antennas. The plurality of antennas may correspond to antenna elements, antenna panels, and/or antenna arrays that may facilitate beamforming operations. For example, the RU 106b transmits a downlink beamformed signal based on a first set of beams 132 to the UE 102b in one or more transmit directions of the RU 106b. The UE 102b may receive the downlink beamformed signal based on a second set of beams 134b from the RU 106b in one or more receive directions of the UE 102b. In a further example, the UE 102b may also transmit an uplink beamformed signal to the RU 106b based on the second set of beams 134b in one or more transmit directions of the UE 102b. The RU 106b may receive the uplink beamformed signal from the UE 102b in one or more receive directions of the RU 106b. The UE 102b may perform beam training to determine the best receive and transmit directions for the beam formed signals. The transmit and receive directions for the UEs 102 and the base stations 104/RUs 106 might or might not be the same. In further examples, beamformed signals may be communicated between a first base station 104c and a second base station 104b. For instance, the RU 106a of cell 190a may transmit a beamformed signal based on the RU beam set 136 to the base station 104c of cell 190e in one or more transmit directions of the RU 106a. The base station 104c of the cell 190e may receive the beamformed signal from the RU 106a based on a base station beam set 138 in one or more receive directions of the base station 104c. Similarly, the base station 104c of the cell 190e may transmit a beamformed signal to the RU 106a based on the base station beam set 138 in one or more transmit directions of the base station 104c. The RU 106a may receive the beamformed signal from the base station 104c of the cell 190e based on the RU beam set 136 in one or more receive directions of the RU 106a.

The base station 104 may include and/or be referred to as a network entity. That is, “network entity” may refer to the base station 104 or at least one unit of the base station 104, such as the RU 106, the DU 108, and/or the CU 110. The base station 104 may also include and/or be referred to as a next generation evolved Node B (ng-eNB), a generation NB (gNB), an evolved NB (eNB), an access point, a base transceiver station, a radio base station, a radio transceiver, a transceiver function, a basic service set (BSS), an extended service set (ESS), a TRP, a network node, network equipment, or other related terminology. The base station 104 or an entity at the base station 104 can be implemented as an IAB node, a relay node, a sidelink node, an aggregated (monolithic) base station with an RU 106 and a BBU that includes a DU 108 and a CU 110, or as a disaggregated base station 104b including one or more of the RU 106, the DU 108, and/or the CU 110. A set of aggregated or disaggregated base stations 104a-104b may be referred to as a next generation-radio access network (NG-RAN). In some examples, the UE 102b operates in dual connectivity (DC) with the base station 104a and the base station 104b. In such cases, the base station 104a can be a master node and the base station 104b can be a secondary node. In other examples, the UE 102b operates in DC with the DU 108a and the DU 108b. In such cases, the DU 108a can be the master node and the DU 108b can be the secondary node.

The core network 120 may include an Access and Mobility Management Function (AMF) 121, a Session Management Function (SMF) 122, a User Plane Function (UPF) 123, a Unified Data Management (UDM) 124, a Gateway Mobile Location Center (GMLC) 125, and/or a Location Management Function (LMF) 126. The core network 120 may also include one or more location servers, which may include the GMLC 125 and the LMF 126, as well as other functional entities. For example, the one or more location servers include one or more location/positioning servers, which may include the GMLC 125 and the LMF 126 in addition to one or more of a position determination entity (PDE), a serving mobile location center (SMLC), a mobile positioning center (MPC), or the like.

The AMF 121 is the control node that processes the signaling between the UEs 102 and the core network 120. The AMF 121 supports registration management, connection management, mobility management, and other functions. The SMF 122 supports session management and other functions. The UPF 123 supports packet routing, packet forwarding, and other functions. The UDM 124 supports the generation of authentication and key agreement (AKA) credentials, user identification handling, access authorization, and subscription management. The GMLC 125 provides an interface for clients/applications (e.g., emergency services) for accessing UE positioning information. The LMF 126 receives measurements and assistance information from the NG-RAN and the UEs 102 via the AMF 121 to compute the position of the UEs 102. The NG-RAN may utilize one or more positioning methods in order to determine the position of the UEs 102. Positioning the UEs 102 may involve signal measurements, a position estimate, and an optional velocity computation based on the measurements. The signal measurements may be made by the UEs 102 and/or the serving base stations 104/RUs 106.

Communicated signals may also be based on one or more of a satellite positioning system (SPS) 114, such as signals measured for positioning. In an example, the SPS 114 of the cell 190c may be in communication with one or more UEs 102, such as the UE 102c, and one or more base stations 104/RUs 106, such as the RU 106c. The SPS 114 may correspond to one or more of a Global Navigation Satellite System (GNSS), a global position system (GPS), a non-terrestrial network (NTN), or other satellite position/location system. The SPS 114 may be associated with LTE signals, NR signals (e.g., based on round trip time (RTT) and/or multi-RTT), wireless local area network (WLAN) signals, a terrestrial beacon system (TBS), sensor-based information, NR enhanced cell ID (NR E-CID) techniques, downlink angle-of-departure (DL-AoD), downlink time difference of arrival (DL-TDOA), uplink time difference of arrival (UL-TDOA), uplink angle-of-arrival (UL-AoA), and/or other systems, signals, or sensors.

The UEs 102 may be configured as a cellular phone, a smart phone, a session initiation protocol (SIP) phone, a laptop, a personal digital assistant (PDA), a satellite radio, a GPS, a multimedia device, a video device, a digital audio player (e.g., moving picture experts group (MPEG) audio layer-3 (MP3) player), a camera, a game console, a tablet, a smart device, a wearable device, a vehicle, an utility meter, a gas pump, appliances, a healthcare device, a sensor/actuator, a display, or any other device of similar functionality. Some of the UEs 102 may be referred to as Internet of Things (IoT) devices, such as parking meters, gas pumps, appliances, vehicles, healthcare equipment, etc. The UE 102 may also be referred to as a station (STA), a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a mobile client, a client, or other similar terminology. The term UE may also apply to a roadside unit (RSU), which may communicate with other RSU UEs, non-RSU UEs, a base station 104, and/or an entity at a base station 104, such as an RU 106.

Still referring to FIG. 1A, in certain aspects, the UE 102 may include a UE Radar Assistance Component 140 configured to receive, from a radar-transmitter, a configuration message that configures the radar-receiver to assist the radar-transmitter with bistatic radar sensing; receive a reflection of the radar signal; and responsive to the receiving the reflection of the radar signal, transmit, to the radar-transmitter, a radar measurement report message.

In certain aspects, the base station 104 or a network entity of the base station 104 may include a Radar Assistance Component 150 configured to receive, from a radar-transmitter, a radar sensing request message requesting the radar-receiver to assist the radar-transmitter with bistatic radar sensing; responsive to the receiving, transmitting, to the radar-transmitter, a physical downlink control channel (PDCCH) grant indicating radar resources; responsive to the receiving the PDCCH grant, receiving a reflection of a radar signal reflected from an object via the radar resources; and responsive to the receiving the reflection of the radar signal, transmitting, to the radar-transmitter, a radar measurement report message.

Accordingly, FIG. 1A describes a wireless communication system that may be implemented in connection with aspects of one or more other figures described herein, such as aspects illustrated in FIGS. 1B-7. Further, although the following description may be focused on 5G NR, the concepts described herein may be applicable to other similar areas, such as 5G-Advanced and future versions, LTE, LTE-advanced (LTE-A), and other wireless technologies, such as 6G.

FIGS. 1B-1C illustrate example environments 170 and 180 for implementing a user equipment (UE) assisted radar processing, according to some embodiments. The environments 170 and 180 include UEs 102 (e.g., 102A, 102B) and a network entity 104.

Referring to FIG. 1B the network entity 104 can act as a radar-transmitter to transmit a radar signal 172 for radar sensing. Radar sensing can be used for imaging an environment or determining information about an object 176 in the environment based on range, Doppler, and/or angle information determined from a reflection of the radar signal 174. The radar signal 172 includes a defined waveform, such as a frequency modulated continuous wave (FMCW), a pulse waveform, or a chirp waveform, among other examples of a defined waveform. Radar sensing can also be employed for automotive radar, e.g., detecting an environment around a vehicle, nearby vehicles or items, detecting information for smart cruise control, collision avoidance, etc. Radar signal sensing can also be employed for gesture recognition, e.g., a human activity recognition, a hand motion recognition, a facial expression recognition, a keystroke detection, sign language detection, etc. Radar signal sensing can be employed to acquire contextual information, e.g., location detection, tracking, determining directions, range estimation, etc. Radar sensing can be employed to image an environment, e.g., to provide a 3-dimensional (3D) map for virtual reality (VR) or augmented reality (AR) applications. Radar devices can be employed to provide high resolution localization, e.g., for industrial Internet-of-things (IoT) applications. The network entity 104 communicates with the UEs 102 using the access link 178 (e.g., wireless link) for control and/or data communication. For example, the network entity 104 communicates control information and downlink data to the UEs 102. The UEs 102 communicate control information and uplink data to the network entity 104. A downlink portion 178A of the access link 178 may be combined with the radar signal 172 to result in a combined radar and communication signal.

The UEs 102 can act as a radar-receiver to receive the reflection of the radar signal 174 reflected from the object 176. When the UE 102 receives a combined radar and communication signal, the UE 102 can demodulate and decode the communication portion of the signal to receive downlink information from the network entity 104. In response to receiving the reflection of the radar signal 174, the UEs 102 transmits, to the network entity 104, information about the object 176 using an uplink portion 178B of the access link 178. After receiving the information about the object 176, the network entity 104 compares the information about the object 176 to the radar signal 172 to determine a location of the object 176.

Referring to FIG. 1C, the UE 102 in the environment 180 can act as a radar-transmitter to transmit a radar signal 172 for radar sensing and possibly also uplink communications. The network entity 104 communicates with the UEs 102 using the access link 178 (e.g., wireless link). The UE 102 may add uplink communication information to the radar signal 172 to result in a combined radar and communication signal. The network entity 104 can demodulate and decode the communication portion of the received combined radar and communication signal. The network entity 104 can act as a radar-receiver to receive the reflection of the radar signal 174 reflected from the object 176. In response to receiving the reflection of the radar signal 174, the network entity 104 transmits, to the UE 102 using the access link 178, information about the object 176. After receiving the information about the object 176, the UE 102 compares the information about the object 176 to the radar signal 172 to determine a location of the object 176.

Thus, the UE and/or the network entity performing the bistatic radar sensing might overcome the limitations associated with conventional monostatic object detection techniques. In addition, the UE and/or the network entity may add communication information to the radar signal to result in a combined radar and communication signal.

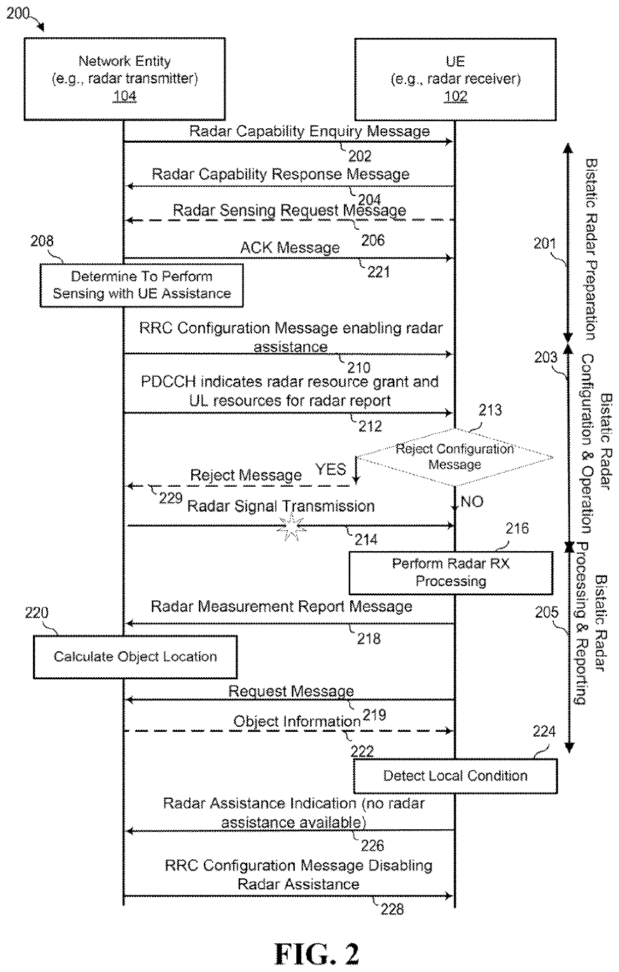

Accordingly, FIGS. 1B-1C describe example environments in which various aspects of UE assisted radar sensing that may be implemented in connection with aspects of one or more other figures described herein, such as aspects illustrated in FIGS. 2-7.

FIG. 2 is a signaling diagram that illustrates example scenario 200 for radar sensing assistance with a network entity 104 (e.g., a base station) as a radar-transmitter and a UE 102 as a radar-receiver, according to some embodiments. Generally speaking, the UE 102 and network entity 104 perform bistatic radar sensing assistance based on three stage operations. The three stage operations include a bistatic radar preparation 201, a bistatic radar configuration and operation 203, and bistatic radar processing and reporting 205. The bistatic radar preparation 201 includes procedures 202, 204, 206, 208, and 221. The bistatic radar configuration and operation 203 includes procedures 210, 212, 213, 214, and 229. The bistatic radar processing and reporting 205 includes procedures 216, 218, 220, 219, and 222.

The radar-receiver (e.g., UE 102) might receive 202, from the radar-transmitter, a radar capability enquiry. For example, the UE 102 receives 202, from the network entity 104, the radar capability enquiry message (e.g., ueCapabilityEnquiry message) requesting a transfer of UE radio access capabilities. In response to receiving the radar capability enquiry or upon the UE's own initiative, the radar-receiver transmits 204 to the radar-transmitter a radar capability response that indicates radar capabilities supported by the radar-receiver for the bistatic radar sensing. For example, the UE 102 transmits 204 to the network entity 104 a radar capability response message (e.g., UECapabilityInformation message) that transfers UE radar capabilities requested by the network entity 104. The radar capability response includes at least one indication of: a radar waveform parameter indicating radar waveforms the radar-receiver can detect; a minimum radar range resolution capability of the radar-receiver; a minimum radar Doppler resolution; a first minimum delay between reception of a physical downlink control channel (PDCCH) grant by the radar-receiver and a first time that the radar-receiver performs a radar reception; or a second minimum delay between the reception of the PDCCH grant and a second time that the radar-receiver performs a radar measurement report transmission.

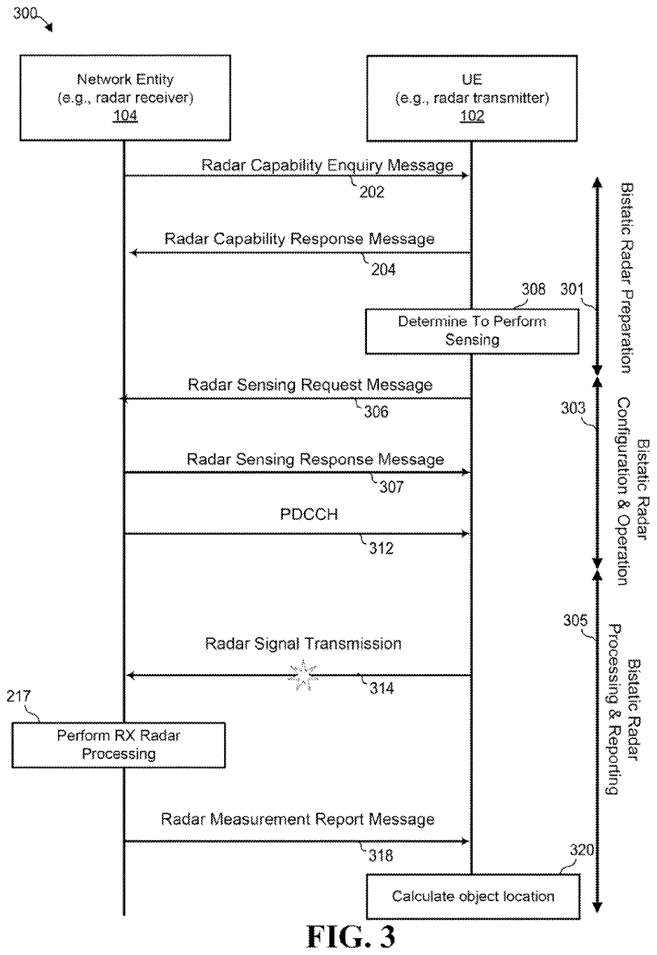

The UE radar capabilities might also include a third minimum time delay between the reception of the PDCCH grant and a third time that the radar-receiver performs a radar transmission. For example, the third minimum time delay can be in a unit of a number of orthogonal frequency-division multiplexing (OFDM) symbols, microseconds, etc. Referring to FIGS. 2 and 3, the third minimum time delay allows the UE to switch from acting as the radar-receiver (FIG. 2) to the radar-transmitter (FIG. 3) for the radar transmission 314. The UE 102 might decode an uplink (UL) PDCCH grant before transmitting the radar signal. The third minimum time delay allows the UE 102 to have enough time to decode the PDCCH grant. The third minimum time differs from the first minimum delay described above. In one example, when the UE 102 does not have full duplex capabilities to perform monostatic radar sensing, the UE 102 might send a request 206 to a network entity 104 to perform bistatic radar sensing. If the network entity 104 is available to perform the bistatic radar sensing with the UE 102, the network entity 104 responds 221 to the UE 102 with an acknowledgement.

The clock source stability determines a synchronization accuracy between the UE 102 and the network entity 104. For example, a high performance crystal oscillator may enhance the synchronization accuracy between the UE 102 and the network entity 104. The radar capability response message may include a synchronization accuracy indication.

The UE radar capabilities also depend on a positioning capability by the UE 102. The positioning capability by the UE 102 might be determined by UE radar resolution capabilities. The UE radar resolution capabilities might include an angular resolution, a range resolution, or a Doppler resolution. The UE radar resolution capabilities might also include a detection range. To perform radar sensing accurately, the UE 102 may be configured with enhanced position resolution. For example, enhanced position resolution might have a higher resolution than a global positioning system (GPS) resolution. In some other example, 5G or 6G network based positioning (e.g., observed time difference of arrival (OTDOA), angle of arrival, angle of departure, etc.) can configure the UE 102 with enhanced position resolution. The radar capability response message may include one or more positioning accuracy indications.

The UE radar capabilities also depend on local operating condition of the UE 102. For example, the UE radar capabilities might be affected by a battery or a thermal condition of the UE 102. The radar capability response message may include a battery or a thermal condition indication.

The radar-transmitter determines 208 to perform a radar sensing assistance procedure 201 with the radar-receiver. For example, based on the UE radar capabilities reported 204 in the radar capability response message, the network entity 104 determines 208 to perform the radar sensing assistance with the UE 102.

To configure the radar-receiver for the radar sensing assistance procedure, the radar-transmitter transmits 210, to the radar-receiver, a configuration message. For example, the UE 102 receives, from the network entity 104, an RRC message (e.g., RRCReconfiguration message). The RRCReconfiguration message may include a new information element (e.g., Radar AssistanceMeasurementConfiguration) to indicate a request for radar sensing assistance. After the radar-receiver receives 210, from the radar-transmitter, the configuration message, the configuration message configures the radar-receiver to assist the radar-transmitter with bistatic radar sensing. For example, the configuration message configures the UE 102 to perform bistatic radar sensing.

The radar-receiver might be one of a group of radar-receivers. If so, the radar-transmitter may define a group identifier (ID) for the group of radar-receivers. For example, the network entity 104 includes the group ID in the configuration message for identifying a group of UEs.

In a group situation, a radar-receiver receives 212 the PDCCH grant indicating radar resources. The radar-receiver might receive, from the radar-transmitter, downlink control information (DCI) that indicates at least one indicator of: a downlink frequency resource; a downlink timing resource; or a radar waveform. The DCI also indicates an uplink resource for the transmitting the radar measurement report message. The radar-transmitter might scramble the PDCCH grant's cyclic redundancy check (CRC) with the group ID.

The radar-receiver might reject 213 the configuration message with an indication that the radar-receiver will not perform the radar sensing assistance. The radar-receiver might send a reject message 229 if the radar-receiver rejects 213 the configuration message. The radar-receiver proceeds to assist the radar-transmitter to perform bistatic radar sensing if the radar-receiver does not reject 213 the configuration message.

Responsive to receiving the PDCCH grant, the radar-transmitter and the radar-receiver performs bistatic radar sensing. For example, the network entity 104 transmits 214 a radar signal 172 into air. The radar signal in this example includes an orthogonal frequency-division multiplexing (OFDM) radar signal. In other examples, the radar signal 172 may include a frequency-modulated continuous-wave (FMCW) radar signal, or a pulsed radar signal. During bistatic radar sensing, the radar signal 172 travels through the air and may impinge on an object (e.g., 176).

When the radar signal 172 impinges on the object 176, the radar signal 172 may change and the radar signal is reflected as a reflection of the radar signal 174. The radar-receiver receives the reflection of the radar signal 174 reflected from the object 176. For example, the reflection of the radar signal 174 may include information about the object 176. Responsive to receiving the reflection of the radar signal, the radar-receiver processes 216 the reflection of the radar signal. For example, the UE 102 processes the reflection of the radar signal 174. By doing so, the UE 102 might detect the object 176 and determine information about the object 176 (e.g., object information).

The radar-receiver then transmits 218, to the radar-transmitter, a radar measurement report message. The radar measurement report message may include information about the object 176 (e.g., object information). The object information may include location information or size information. The radar-transmitter may use the object information to calculate 220 a range of the object 176 to determine the location of the object 176. In some examples, the radar-transmitter may use the object information to determine a presence or movement of the object 176, a speed of the object 176, a distance between the radar-transmitter and the object 176, a distance between the radar-receiver and the object 176, a direction of movement of the object, and an elevation angle, a size of the object 176, a material composition of the object 176. In some other examples, the radar measurement report message may include at least one indication of: a Doppler velocity, a Doppler spread, a Doppler shift, or a radar signal propagation delay information. After the radar-transmitter calculates 220 the range of the object 176 to determine the location of the object 176, the radar-transmitter might transmit 222 the object information to the radar-receiver. In some examples. the radar-receiver transmits 219, to the radar-transmitter, a request message requesting the radar-transmitter to transmit 222 object information after the radar-transmitter determines object information from the reflection of the radar signal.

The radar-receiver might transmit 226, to the radar-transmitter, a first message indicating that the radar-receiver is not available for the radar sensing assistance. In response to the transmitting the first message, the radar-receiver might receive 228, from the radar-transmitter, a second message to disregard a radar assistance request. For example, the UE 102 receives a RRC message to disregard the configuration message as described above.

The radar-receiver might transmit 226 the first message indicating the radar-receiver is not available for the radar sensing assistance because the radar-receiver detects 224 a condition of the radar-receiver. For example, when sensors of the UE 102 detect local conditions of the UE 102, the UE 102 transmits the first message that indicates the UE 102 is not available to perform radar sensing assistance with the network entity 104. The local conditions of the UE 102 may include battery level condition, thermal condition, processing capacity, available memory. The UE 102 might transmit the first message if the battery level, processing capacity, or available memory fall below a certain threshold. Additionally or alternatively, the UE might transmit the first message if a temperature of the UE is outside of a certain temperature range due to overheating. FIG. 2 describes an example scenario 200 in which the network entity configured as a radar-transmitter and the UE configured as a radar-receiver for radar sensing assistance, whereas FIG. 3 describes another example scenario 300 in which the UE configured as a radar-transmitter and the network entity configured as a radar-receiver for radar sensing assistance.

FIG. 3 is a signaling diagram that illustrates example scenario 300 with the UE 102 as the radar-transmitter and the network entity 104 as the radar-receiver, according to some embodiments. Example scenario 300 can be implemented by the UE 102 communicating with the network entity 104 depicted in FIGS. 1A-1B.

Referring to FIG. 3, generally speaking, the UE 102 and network entity 104 perform bistatic radar sensing assistance based on three stage operations. The three stage operations include a bistatic radar preparation 301, a bistatic radar configuration and operation 303, and bistatic radar processing and reporting 305. The bistatic radar preparation 301 includes procedures 202, 204, and 308. The bistatic radar configuration and operation 303 includes procedures 306, 307, and 312. The bistatic radar processing and reporting 305 includes procedures 217, 314, 318, and 320. The procedures 202, 204, 308, 312 may be similar to procedures 202, 204, 208, 212 of FIG. 2. In some aspects, a radar-transmitter might transmit, to a radar-receiver, a radar sensing request message requesting a radar-receiver to assist the radar-transmitter with bistatic radar sensing. For example, the UE 102 determines to perform radar sensing, the UE 102 transmits 306 a radar sensing request message requesting the network entity 104 to assist the network entity 104 with bistatic radar sensing. Responsive to the transmitting 306, the radar-transmitter receives 212, from the radar-receiver, a physical downlink control channel (PDCCH) grant indicating radar resources. For example, the UE 102 receives 212, from the network entity 104, the PDCCH grant indicating radar resources. Responsive to the receiving, the radar-transmitter transmits 314 a radar signal using the radar resources and toward a region of interest. Responsive to receiving the reflection of the radar signal, the radar-receiver processes 217 the reflection of the radar signal. For example, the network entity 104 processes the reflection of the radar signal 174. By doing so, the network entity 104 might determine information about the object 176 (e.g., object information). After that, the radar-transmitter receives 318, from the radar-receiver responsive to the transmitting the radar signal, a radar measurement report message. After the radar-transmitter receives 318 the radar measurement report message, the radar-transmitter might calculate 320 the range of the object 176 to determine the location of the object 176.

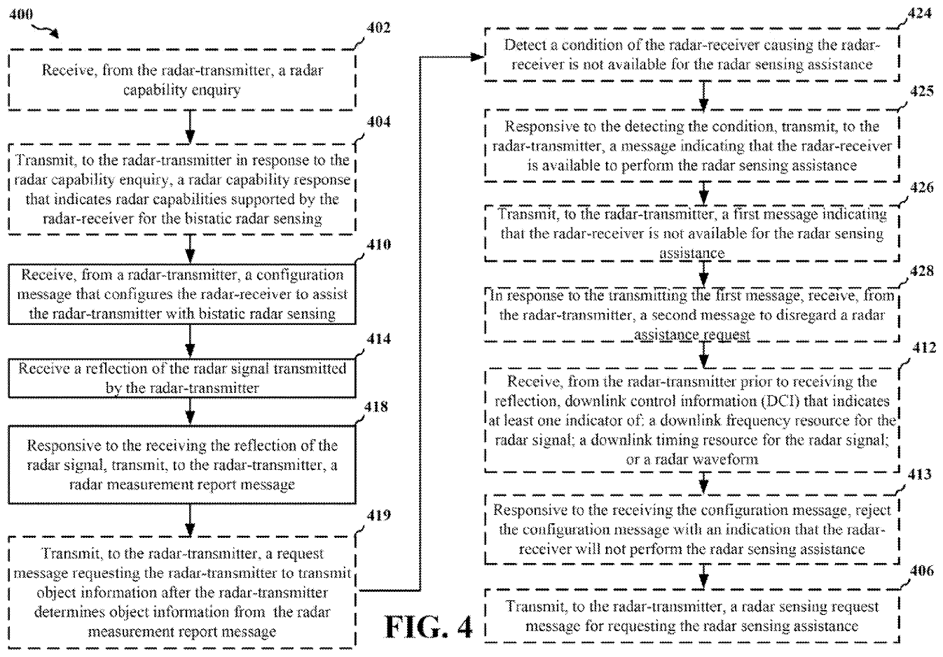

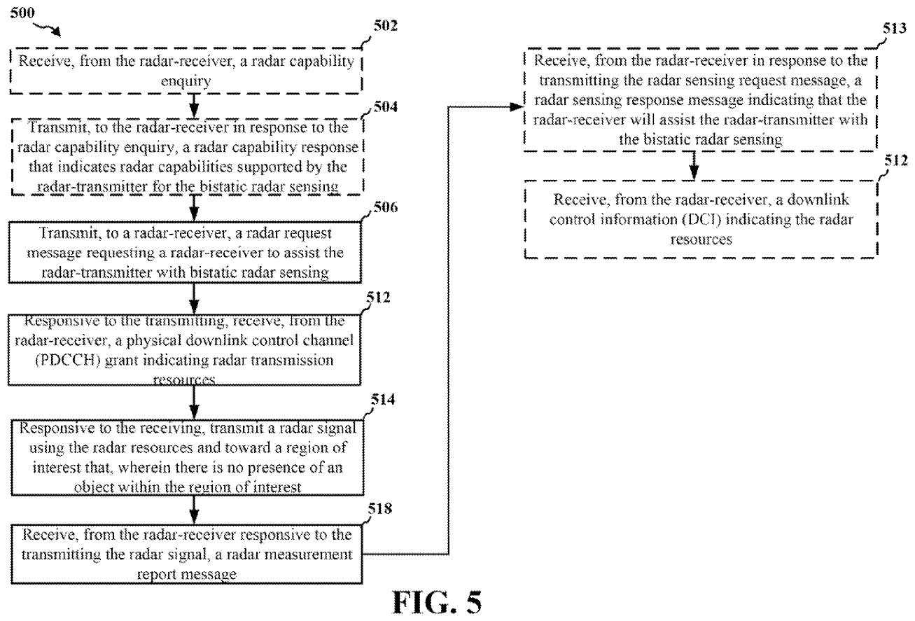

FIGS. 2-3 illustrate bistatic radar sensing at a radar-receiver and bistatic radar sensing at a radar-transmitter. FIGS. 4-5 show methods for implementing one or more aspects of FIGS. 2-3. In particular, FIG. 4 shows an implementation by a radar-receiver of the one or more aspects of FIGS. 2-3. FIG. 5 shows an implementation by a radar-transmitter of the one or more aspects of FIGS. 2-3.

FIG. 4 is a flow diagram depicting an example method, implemented at a radar-receiver, of performing radar sensing assistance. With reference to FIGS. 1-3 and 6-7, the method may be performed by the radar-receiver (e.g., UE 102), the UE apparatus 602, etc., which may include the memory 626′ and which may correspond to the entire UE 102 or the UE apparatus 602, or a component of the UE 102 or the UE apparatus 602, such as the wireless baseband processor 626, and/or the application processor 606. In further examples, the network entity 104 may be the radar-receiver.

The radar-receiver might receive 402, from a radar-transmitter, a radar capability enquiry. Referring to FIG. 2, for example, the UE 102 receives 202, from the network entity 104, the radar capability enquiry message (e.g., ueCapabilityEnquiry message) requesting a transfer of UE radio access capabilities.

In response to receiving 402 the radar capability enquiry, the radar-receiver might transmit 404, to the radar-transmitter, a radar capability response that indicates radar capabilities supported by the radar-receiver for the bistatic radar sensing. Referring to FIG. 2, for example, the UE 102 transmits 204 to the network entity 104 a radar capability response message (e.g., UECapabilityInformation message) that transfers UE radar capabilities requested by the network entity 104.

The radar-receiver receives 410, from the radar-transmitter a configuration message. Referring to FIG. 2, for example, the UE 102 receives 210, from the network entity 104, an RRC message (e.g., RRCReconfiguration message). The RRCReconfiguration message may include a new information element (e.g., Radar AssistanceMeasurementConfiguration) to indicate a request for radar sensing assistance.

Responsive to receiving the PDCCH grant, the radar-transmitter transmits 414 a radar signal. For example, the network entity transmits 214 a radar signal 172 into air and the radar-receiver receives 214 the radar signal.

The radar-receiver then transmits 418, to the radar-transmitter, a radar measurement report message. For example, referring to FIG. 2, the UE 102 transmits 218, to the network entity 104, the radar measurement report message including information about the object 176 (e.g., object information).

The radar-receiver might transmit 419, to the radar-transmitter, a request message requesting the radar-transmitter to transmit object information after the radar-transmitter determines object information from the reflection of the radar signal. For example, referring to FIG. 2, the UE 102 transmits 219, to the network entity 104, the request message requesting the network entity 104 to transmit object information after the network entity 104 determines 220 object information from the reflection of the radar signal.

The radar-receiver might detect 424 a condition of the radar-receiver causing the radar-receiver is not available for the radar sensing assistance. For example, the UE 102 detects local conditions (battery level or thermal condition) of the UE 102 using various sensors (e.g., 618). Upon detection of the local conditions, the UE 102 is not available to perform radar sensing assistance with the network entity 104.

Responsive to the detecting the condition, the radar-receiver might transmit 425, to the radar-transmitter, a message indicating that the radar-receiver is available to perform the radar sensing assistance. For example, referring to FIG. 2, when the UE 102 detects 224 local conditions of the UE 102, the UE 102 226 transmits the message that indicates the UE 102 is not available to perform radar sensing assistance with the network entity 104.

The radar-receiver might transmit 426, to the radar-transmitter, a first message indicating that the radar-receiver is not available for the radar sensing assistance. Referring to FIG. 2, the UE 102 transmits 226, to the network entity 104, the first message indicating that the UE 102 is not available for the radar sensing assistance.

In response to the transmitting the first message, the radar-receiver might receive 428, from the radar-transmitter, a second message to disregard a radar assistance request. Referring to FIG. 2, the UE 102 receives 228, from the network entity 104, the second message to disregard the configuration message as described above.

The radar-receiver might receive 412, from the radar-transmitter, downlink control information (DCI) that indicates at least one indicator of: a downlink frequency resource; a downlink timing resource; or a radar waveform. For example, referring to FIG. 2, the UE 102 receives 212, from the network entity, the PDCCH grant indicating radar resources.

Responsive to the receiving the configuration message, the radar-receiver might reject 413 the configuration message with an indication that the radar-receiver will not perform the radar sensing assistance. Referring to FIG. 2, the UE 102 rejects 213 the configuration message with an indication that the UE 102 will not perform the radar sensing assistance. The UE 102 sends a reject message 229 if the UE 102 rejects 213 the configuration message. The UE 102 proceeds to assist the network entity 104 to perform bistatic radar sensing if the UE 102 does not reject 213 the configuration message.

The radar-receiver might transmit 406, to the radar-transmitter, a radar sensing request message for requesting the radar sensing assistance. For example, referring to FIG. 2, the UE 102 transmits, to the network entity 104, the radar sensing request message that indicates a request for the radar sensing assistance from the network entity 104. FIG. 4 describes a method from a radar-receiver-side for radar sensing assistance, whereas FIG. 5 describes a method from a radar-transmitter-side for radar sensing assistance.

FIG. 5 is a flow diagram depicting an example method, implemented in a radar-transmitter, of performing radar sensing assistance. With reference to FIGS. 1-3 and 11, the method may be performed by a network entity 104, such as a base station or a unit of a base station, which may correspond to an RU processor 706, a DU processor 726, a CU processor 746, etc. The one or more network entities 104 may include the memory 706′/726′/746″, which may correspond to an entirety of the one or more network entities 104, or a component of the one or more network entities 104, such as the RU processor 706, the DU processor 726, or the CU processor 746. In further examples, the UE 102 might be the radar-transmitter.

In the method 500, the radar-transmitter might receive 502, from a radar-receiver, a radar capability enquiry. Referring to FIG. 2, for example, the UE 102 receives 202, from the network entity 104, the radar capability enquiry message (e.g., ueCapabilityEnquiry message) requesting a transfer of UE radio access capabilities.

The radar-transmitter, might transmit 504, to the radar-receiver in response to the radar capability enquiry, a radar capability response that indicates radar capabilities supported by the radar-transmitter for the bistatic radar sensing. Referring to FIG. 2, for example, the UE 102 transmits 204 to the network entity 104 a radar capability response message (e.g., UECapabilityInformation message) that transfers UE radar capabilities requested by the network entity 104.

The radar-transmitter, transmit 506, to a radar-receiver, a radar sensing request message requesting a radar-receiver to assist the radar-transmitter with bistatic radar sensing. Referring to FIG. 2, for example, the UE 102 transmits 206, to the network entity 104, the radar sensing request message requesting the network entity 104 to assist the UE102 with bistatic radar sensing.

Responsive to the transmitting, the radar-transmitter receives 512, from the radar-receiver, a physical downlink control channel (PDCCH) grant indicating radar resources. For example, the UE 102 receives 212, from the network entity 104, the PDCCH grant indicating radar resources.

The radar-transmitter transmits 514 a radar signal using the radar resources and toward a region of interest. Referring to FIG. 3, for example, the UE 102 transmits 314 a radar signal 172 into air and the network entity 104 receives 214 the radar signal.

The radar-transmitter receives 518, from the radar-receiver responsive to the transmitting the radar signal, a radar measurement report message. Referring to FIG. 3, for example, the UE receives 318, from the network entity 104 responsive to the transmitting the radar signal, the radar measurement report message.

The radar-transmitter receives 513, from the radar-receiver, an acknowledgment message indicating that the radar-receiver assists the radar-transmitter for the bistatic radar sensing. Referring to FIG. 3, for example, the UE 102 receives 307, from the network entity 104 the radar sensing response message indicating that the UE 102 assists the network entity 104 for the bistatic radar sensing.

The radar-transmitter receives 512, from the radar-receiver, a downlink control information (DCI) indicating the radar resources. Referring to FIG. 3, for example, the UE 102 receives 312, from the network entity 104, the DCI indicating radar resources.

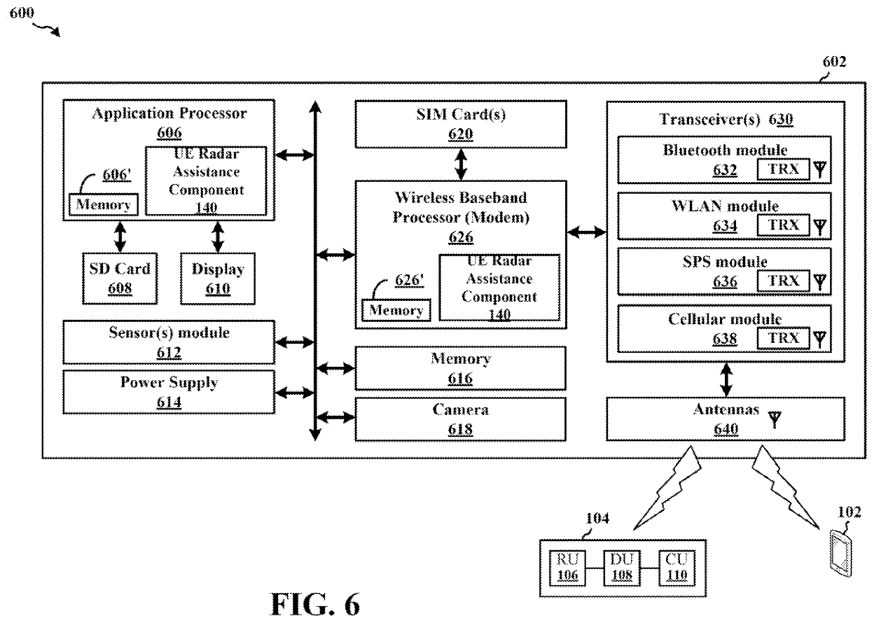

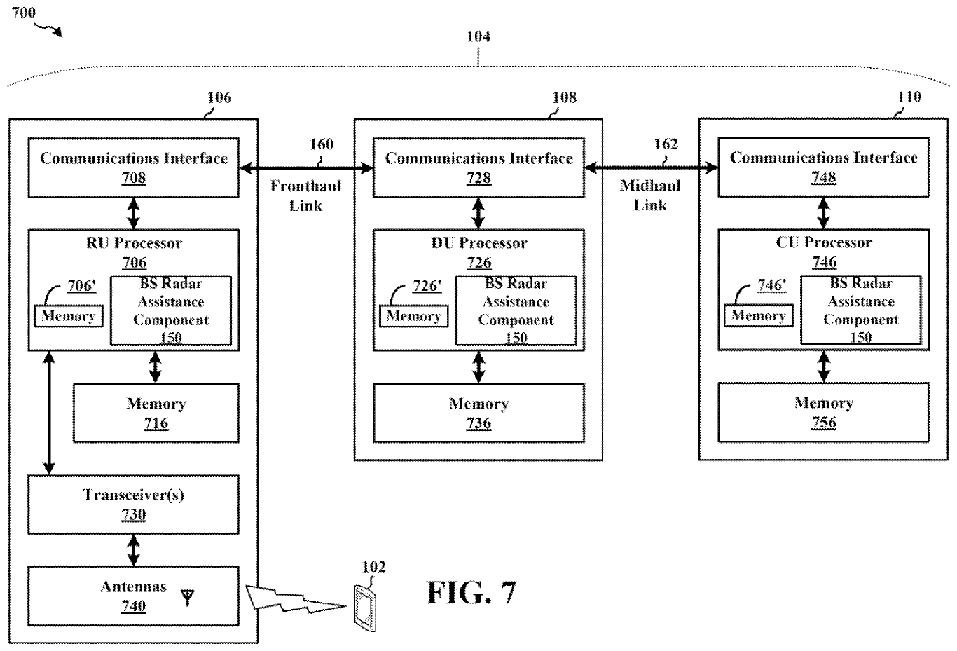

A UE apparatus 600, as described in FIG. 6, may operate as either a radar-transmitter or a radar-receiver and may perform the method of flowcharts 400, 500. The one or more network entities 104, as described in FIG. 7, may also operate as either the radar-transmitter or the radar-receiver and may also perform the method of flowcharts 400, 500.

FIG. 6 is a diagram 600 illustrating an example of a hardware implementation for a UE apparatus 602. The UE apparatus 602 may be the UE 102, a component of the UE 102, or may implement UE functionality. The UE apparatus 602 may include an application processor 606, which may have on-chip memory 606″. In examples, the application processor 606 may be coupled to a secure digital (SD) card 608 and/or a display 610. The application processor 606 may also be coupled to a sensor(s) module 612, a power supply 614, an additional module of memory 616, a camera 618, and/or other related components. For example, the sensor(s) module 612 may control a barometric pressure sensor/altimeter, a motion sensor such as an inertial management unit (IMU), a gyroscope, accelerometer(s), a light detection and ranging (LIDAR) device, a radio-assisted detection and ranging (RADAR) device, a sound navigation and ranging (SONAR) device, a magnetometer, an audio device, and/or other technologies used for positioning.

The UE apparatus 602 may further include a wireless baseband processor 626, which may be referred to as a modem. The wireless baseband processor 626 may have on-chip memory 626′. Along with, and similar to, the application processor 606, the wireless baseband processor 626 may also be coupled to the sensor(s) module 612, the power supply 614, the additional module of memory 616, the camera 618, and/or other related components. The wireless baseband processor 626 may be additionally coupled to one or more subscriber identity module (SIM) card(s) 620 and/or one or more transceivers 630 (e.g., wireless RF transceivers).

Within the one or more transceivers 630, the UE apparatus 602 may include a Bluetooth module 632, a WLAN module 634, an SPS module 636 (e.g., GNSS module), and/or a cellular module 638. The Bluetooth module 632, the WLAN module 634, the SPS module 636, and the cellular module 638 may each include an on-chip transceiver (TRX), or in some cases, just a transmitter (TX) or just a receiver (RX). The Bluetooth module 632, the WLAN module 634, the SPS module 636, and the cellular module 638 may each include dedicated antennas and/or utilize antennas 640 for communication with one or more other nodes. For example, the UE apparatus 602 can communicate through the transceiver(s) 630 via the antennas 640 with another UE 102 (e.g., sidelink communication) and/or with a network entity 104 (e.g., uplink/downlink communication), where the network entity 104 may correspond to a base station or a unit of the base station, such as the RU 106, the DU 108, or the CU 110.

The wireless baseband processor 626 and the application processor 606 may each include a computer-readable medium/memory 626′, 606′, respectively. The additional module of memory 616 may also be considered a computer-readable medium/memory. Each computer-readable medium/memory 626′, 606′, 616 may be non-transitory. The wireless baseband processor 626 and the application processor 606 may each be responsible for general processing, including execution of software stored on the computer-readable medium/memory 626′, 606′, 616. The software, when executed by the wireless baseband processor 626/application processor 606, causes the wireless baseband processor 626/application processor 606 to perform the various functions described herein. The computer-readable medium/memory may also be used for storing data that is manipulated by the wireless baseband processor 626/application processor 606 when executing the software. The wireless baseband processor 626/application processor 606 may be a component of the UE 102. The UE apparatus 602 may be a processor chip (e.g., modem and/or application) and include just the wireless baseband processor 626 and/or the application processor 606. In other examples, the UE apparatus 602 may be the entire UE 102 and include the additional modules of the apparatus 602.

As discussed, the UE Radar Assistance component 140 is configured to receive, from a radar-transmitter, a configuration message that configures the radar-receiver to assist the radar-transmitter with bistatic radar sensing; receive a reflection of the radar signal; and responsive to the receiving the reflection of the radar signal, transmit, to the radar-transmitter, a radar measurement report message. The UE Radar Assistance component 140 may be within the wireless baseband processor 626, the application processor 606, or both the wireless baseband processor 626 and the application processor 606. The UE Radar Assistance component 140 may be one or more hardware components specifically configured to carry out the stated processes/algorithm, implemented by one or more processors configured to perform the stated processes/algorithm, stored within a computer-readable medium for implementation by one or more processors, or some combination thereof.

As shown, the apparatus 600 may include a variety of components configured for various functions. In one configuration, the apparatus 600, and in particular the wireless baseband processor 626 and/or the application processor 606, includes means for receiving, from a radar-transmitter, a configuration message that configures the radar-receiver to assist the radar-transmitter with bistatic radar sensing; means for receiving a reflection of the radar signal; Responsive to the receiving the reflection of the radar signal, means for transmitting, to the radar-transmitter, a radar measurement report message. The apparatus 600 further includes means for Receiving, from the radar-transmitter, a radar capability enquiry; and means for Transmitting, to the radar-transmitter in response to the radar capability enquiry, a radar capability response that indicates radar capabilities supported by the radar-receiver for the bistatic radar sensing. The means may be the UE Radar Assistance component 140 of the apparatus 600 configured to perform the functions recited by the means.

FIG. 7 is a diagram 700 illustrating an example of a hardware implementation for one or more network entities 104. The one or more network entities 104 may be a base station, a component of a base station, or may implement base station functionality. The one or more network entities 104 may include, or may correspond to, at least one of the RU 106, the DU, 108, or the CU 110. The CU 110 may include a CU processor 746, which may have on-chip memory 746′. In some aspects, the CU 110 may further include an additional module of memory 756 and/or a communications interface 748, both of which may be coupled to the CU processor 746. The CU 110 can communicate with the DU 108 through a midhaul link 162, such as an Fl interface between the communications interface 748 of the CU 110 and a communications interface 728 of the DU 108.

The DU 108 may include a DU processor 726, which may have on-chip memory 726′. In some aspects, the DU 108 may further include an additional module of memory 736 and/or the communications interface 728, both of which may be coupled to the DU processor 726. The DU 108 can communicate with the RU 106 through a fronthaul link 160 between the communications interface 728 of the DU 108 and a communications interface 708 of the RU 106.

The RU 106 may include an RU processor 706, which may have on-chip memory 706′. In some aspects, the RU 106 may further include an additional module of memory 716, the communications interface 708, and one or more transceivers 730, all of which may be coupled to the RU processor 706. The RU 106 may further include antennas 740, which may be coupled to the one or more transceivers 730, such that the RU 106 can communicate through the one or more transceivers 730 via the antennas 740 with the UE 102.

The on-chip memory 706′, 726′, 746′ and the additional modules of memory 716, 736, 756 may each be considered a computer-readable medium/memory. Each computer-readable medium/memory may be non-transitory. Each of the processors 706, 726, 746 is responsible for general processing, including execution of software stored on the computer-readable medium/memory. The software, when executed by the corresponding processor(s) 706, 726, 746 causes the processor(s) 706, 726, 746 to perform the various functions described herein. The computer-readable medium/memory may also be used for storing data that is manipulated by the processor(s) 706, 726, 746 when executing the software. In examples, the BS radar assistant component 150 may sit at the one or more network entities 104, such as at the CU 110; both the CU 110 and the DU 108; each of the CU 110, the DU 108, and the RU 106; the DU 108; both the DU 108 and the RU 106; or the RU 106.

As discussed, the BS Radar Assistance component 150 configured to receive, from a radar-transmitter, a radar sensing request message requesting the radar-receiver to assist the radar-transmitter with bistatic radar sensing; responsive to the receiving, transmitting, to the radar-transmitter, a physical downlink control channel (PDCCH) grant indicating radar resources; responsive to the receiving the PDCCH grant, receiving a reflection of a radar signal reflected from an object via the radar resources; and responsive to the receiving the reflection of the radar signal, transmitting, to the radar-transmitter, a radar measurement report message. The BS Radar Assistance component 150 may be within one or more processors of one or more of the CU 110, DU 108, and the RU 106. The BS Radar Assistance component 150 may be one or more hardware components specifically configured to carry out the stated processes/algorithm, implemented by one or more processors configured to perform the stated processes/algorithm, stored within a computer-readable medium for implementation by one or more processors, or some combination thereof.

The one or more network entities 104 may include a variety of components configured for various functions. In one configuration, the one or more network entities 104 includes means for receiving, from a radar-transmitter, a radar sensing request message requesting the radar-receiver to assist the radar-transmitter with bistatic radar sensing; responsive to the receiving, means for transmitting, to the radar-transmitter, a physical downlink control channel (PDCCH) grant indicating radar resources; responsive to the receiving the PDCCH grant, means for receiving a reflection of a radar signal reflected from an object via the radar resources; and responsive to the receiving the reflection of the radar signal, means for transmitting, to the radar-transmitter, a radar measurement report message. The means may be the BS Radar Assistance component 150 of the one or more network entities 104 configured to perform the functions recited by the means.

The specific order or hierarchy of blocks in the processes and flowcharts disclosed herein is an illustration of example approaches. Hence, the specific order or hierarchy of blocks in the processes and flowcharts may be rearranged. Some blocks may also be combined or deleted. Dashed lines may indicate optional elements of the diagrams. The accompanying method claims present elements of the various blocks in an example order, and are not limited to the specific order or hierarchy presented in the claims, processes, and flowcharts.

The detailed description set forth herein describes various configurations in connection with the drawings and does not represent the only configurations in which the concepts described herein may be practiced. The detailed description includes specific details for the purpose of providing a thorough explanation of various concepts. However, these concepts may be practiced without these specific details. In some instances, well known structures and components are shown in block diagram form in order to avoid obscuring such concepts.

Aspects of wireless communication systems, such as telecommunication systems, are presented with reference to various apparatuses and methods. These apparatuses and methods are described in the following detailed description and are illustrated in the accompanying drawings by various blocks, components, circuits, processes, call flows, systems, algorithms, etc. (collectively referred to as “elements”). These elements may be implemented using electronic hardware, computer software, or combinations thereof. Whether such elements are implemented as hardware or software depends upon the particular application and design constraints imposed on the overall system.

An element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems-on-chip (SoC), baseband processors, field programmable gate arrays (FPGAs), programmable logic devices (PLDs), state machines, gated logic, discrete hardware circuits, and other similar hardware configured to perform the various functionality described throughout this disclosure. One or more processors in the processing system may execute software, which may be referred to as software, firmware, middleware, microcode, hardware description language, or otherwise. Software shall be construed broadly to mean instructions, instruction sets, code, code segments, program code, programs, subprograms, software components, applications, software applications, software packages, routines, subroutines, objects, executables, threads of execution, procedures, functions, or any combination thereof.

If the functionality described herein is implemented in software, the functions may be stored on, or encoded as, one or more instructions or code on a computer-readable medium, such as a non-transitory computer-readable storage medium. Computer-readable media includes computer storage media and can include a random-access memory (RAM), a read-only memory (ROM), an electrically erasable programmable ROM (EEPROM), optical disk storage, magnetic disk storage, other magnetic storage devices, combinations of these types of computer-readable media, or any other medium that can be used to store computer executable code in the form of instructions or data structures that can be accessed by a computer. Storage media may be any available media that can be accessed by a computer.

Aspects, implementations, and/or use cases described herein may be implemented across many differing platform types, devices, systems, shapes, sizes, and packaging arrangements. For example, the aspects, implementations, and/or use cases may come about via integrated chip implementations and other non-module-component based devices, such as end-user devices, vehicles, communication devices, computing devices, industrial equipment, retail/purchasing devices, medical devices, artificial intelligence (AI)-enabled devices, machine learning (ML)-enabled devices, etc. The aspects, implementations, and/or use cases may range from chip-level or modular components to non-modular or non-chip-level implementations, and further to aggregate, distributed, or original equipment manufacturer (OEM) devices or systems incorporating one or more techniques described herein.

Devices incorporating the aspects and features described herein may also include additional components and features for the implementation and practice of the claimed and described aspects and features. For example, transmission and reception of wireless signals necessarily includes a number of components for analog and digital purposes, such as hardware components, antennas, RF-chains, power amplifiers, modulators, buffers, processor(s), interleavers, adders/summers, etc. Techniques described herein may be practiced in a wide variety of devices, chip-level components, systems, distributed arrangements, aggregated or disaggregated components, end-user devices, etc., of varying configurations.

The description herein is provided to enable a person skilled in the art to practice the various aspects described herein. Various modifications to these aspects will be readily apparent to those skilled in the art, and the generic principles defined herein may be applied to other aspects. Thus, the claims are not limited to the aspects described herein, but are to be interpreted in view of the full scope of the present disclosure consistent with the language of the claims.

Reference to an element in the singular does not mean “one and only one” unless specifically stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. Unless specifically stated otherwise, the term “some” refers to one or more. Combinations such as “at least one of A, B, or C” or “one or more of A, B, or C” include any combination of A, B, and/or C, such as A and B, A and C, B and C, or A and B and C, and may include multiples of A, multiples of B, and/or multiples of C, or may include A only, B only, or C only. Sets should be interpreted as a set of elements where the elements number one or more.

Unless otherwise specifically indicated, ordinal terms such as “first” and “second” do not necessarily imply an order in time, sequence, numerical value, etc., but are used to distinguish between different instances of a term or phrase that follows each ordinal term.

Structural and functional equivalents to elements of the various aspects described throughout this disclosure that are known or later come to be known to those of ordinary skill in the art are expressly incorporated herein by reference and are encompassed by the claims. The words “module,” “mechanism,” “element,” “device,” and the like may not be a substitute for the word “means.” As such, no claim element is to be construed as a means plus function unless the element is expressly recited using the phrase “means for.” As used herein, the phrase “based on” shall not be construed as a reference to a closed set of information, one or more conditions, one or more factors, or the like. In other words, the phrase “based on A”, where “A” may be information, a condition, a factor, or the like, shall be construed as “based at least on A” unless specifically recited differently.

The following examples are illustrative only and may be combined with other examples or teachings described herein, without limitation.

Example 1 is a method of radar sensing assistance at a radar-receiver, including: receiving, from a radar-transmitter, a configuration message that configures the radar-receiver to assist the radar-transmitter with bistatic radar sensing; receiving a reflection of a radar signal transmitted by the radar-transmitter ; and responsive to the receiving the reflection of the radar signal, transmitting, to the radar-transmitter, a radar measurement report message.

Example 2 may be combined with example 1 and further includes receiving, from the radar-transmitter, a radar capability enquiry; and transmitting, to the radar-transmitter in response to the radar capability enquiry, a radar capability response that indicates radar capabilities supported by the radar-receiver for the bistatic radar sensing.

Example 3 may be combined with example 1 to 2 and further includes transmitting, to the radar-transmitter, a request message requesting the radar-transmitter to transmit object information after the radar-transmitter determines object information from the radar measurement report message.

Example 4 may be combined with example 1 to 3 and includes that the object information includes object location information or object size information.

Example 5 may be combined with example 1 to 4 and further includes transmitting, to the radar-transmitter, a first message indicating that the radar-receiver is not available for the radar sensing assistance; and in response to the transmitting the first message, receiving, from the radar-transmitter, a second message to disregard a radar assistance request.

Example 6 may be combined with example 1 to 5 and includes that the transmitting the first message is caused by detecting a condition of the radar-receiver indicating the radar-receiver is not available for the radar sensing assistance.

Example 7 may be combined with example 5 to 6 and includes that the condition of the radar-receiver is: a temperature condition, or a battery condition.

Example 8 may be combined with example 1 to 7 and includes that the receiving the configuration message includes: receiving the configuration message via a Radio Resource Control (RRC) message.

Example 9 may be combined with example 1 to 8 and includes that the radar-receiver is one of a plurality of radar-receivers, and the configuration message includes a group identifier (ID) for identifying the plurality of radar-receivers.

Example 10 may be combined with example 1 to 9 and further includes receiving, from the radar-transmitter prior to receiving the reflection, downlink control information (DCI) that indicates at least one indicator of: a downlink frequency resource for the radar signal; a downlink timing resource for the radar signal; or a radar waveform.

Example 11 may be combined with example 10 and includes that the DCI also indicates an uplink resource for the transmitting the radar measurement report message.

Example 12 may be combined with example 1 to 11 and further includes responsive to the receiving the configuration message, rejecting the configuration message with an indication that the radar-receiver will not perform the radar sensing assistance.

Example 13 may be combined with example 1 to 12 and further transmitting, to the radar-transmitter, a radar sensing request message for requesting the radar sensing assistance.

Example 14 may be combined with example 1 to 13 and includes that the radar-transmitter is a network entity and the radar-receiver is a user equipment (UE).

Example 15 is a method of radar sensing assistance at a radar-transmitter, including: transmitting, to a radar-receiver, a configuration message for configuring the radar-receiver to assist the radar-transmitter with bistatic radar sensing; transmitting a radar signal toward a region of interest; and receiving, from the radar-receiver responsive to the transmitting the radar signal, a radar measurement report message.

Example 16 is a method of radar sensing assistance at a radar-transmitter, including: transmitting, to a radar-receiver, a radar sensing request message requesting a radar-receiver to assist the radar-transmitter with bistatic radar sensing; responsive to the transmitting, receiving, from the radar-receiver, a physical downlink control channel (PDCCH) grant indicating radar transmission resources; responsive to the receiving, transmitting a radar signal using the radar transmission resources and toward a region of interest; and receiving, from the radar-receiver responsive to the transmitting the radar signal, a radar measurement report message.

Example 17 may be combined with example 16 and further includes receiving, from the radar-receiver, a radar capability enquiry; and transmitting, to the radar-receiver in response to the radar capability enquiry, a radar capability response that indicates radar capabilities supported by the radar-transmitter for the bistatic radar sensing.

Example 18 may be combined with example 17 and further receiving, from the radar-receiver in response to the transmitting the radar sensing request message, a radar sensing response message indicating that the radar-receiver will assist the radar-transmitter with the bistatic radar sensing.

Example 19 may be combined with example 2, 18 to 20 and includes that the radar capability response includes at least one indication of: a radar waveform parameter indicating a radar waveform the radar-transmitter is capable detecting; a minimum radar range resolution capability of the radar-transmitter; a minimum radar Doppler resolution; a first minimum delay between a reception of the PDCCH grant by the radar-transmitter and a first time that the radar-transmitter is configured for the receiving the reflection; or a second minimum delay between the reception of the PDCCH grant and a second time that the radar-transmitter is configured for the transmitting the measurement report message.

Example 20 may be combined with example 16 to 19 and further includes that the receiving the PDCCH grant includes receiving a downlink control information (DCI) indicating the radar transmission resources.

Example 21 may be combined with example 16 to 20 and includes that the PDCCH grant comprises at least one indicator of: a downlink frequency resource for the radar signal; a downlink timing resource for the radar signal; or the radar waveform.

Example 22 may be combined with example 16 to 21 and includes the PDCCH grant indicates an uplink resource for a transmission of the radar measurement report message.

Example 23 may be combined with example 1 to 13 or 16 to 22 and includes that the radar measurement report message includes at least one indication of: Doppler velocity, a Doppler spread, a Doppler shift, or a radar signal propagation delay information.

Example 24 may be combined with example 17 to 23 and includes that the radar-transmitter is a user equipment (UE) and the radar-receiver is a network entity.

Example 25 is a method of radar sensing assistance at a radar-receiver, including receiving, from a radar-transmitter, a radar sensing request message requesting the radar-receiver to assist the radar-transmitter with bistatic radar sensing; responsive to the receiving, transmitting, to the radar-transmitter, a physical downlink control channel (PDCCH) grant indicating radar resources; responsive to the receiving the PDCCH grant, receiving a reflection of a radar signal transmitted by the radar-transmitter; and responsive to the receiving the reflection of the radar signal, transmitting, to the radar-transmitter, a radar measurement report message.

Example 26 may be combined with any of the preceding example and includes that the radar signal is: an orthogonal frequency-division multiplexing (OFDM) radar signal, a frequency-modulated continuous-wave (FMCW) radar signal, or a pulsed radar signal.

Example 27 may be combined with any of the preceding example and includes that the radar signal includes a communication component and the radar-receiver demodulates and decodes the communication component.

Example 28 is an apparatus for wireless communication including a memory and a processor coupled to the memory and configured to implement a method as in any of claims 1-27.

Example 29 is a non-transitory computer-readable medium storing computer executable code, the code when executed by a processor causes the processor to implement a method as in any one of claims 1-27.

What is claimed is:

1-15. (canceled)

16. A method of radar sensing assistance at a radar-receiver, comprising:
transmitting, to a radar-transmitter, a radar sensing request message for requesting radar sensing assistance;
receiving, from the radar-transmitter, a physical downlink control channel (PDCCH) indication of a first resource grant for radar signal reception and a second resource grant for radar measurement report message transmission;
receiving, using the first resource grant, a reflection of a radar signal transmitted by the radar-transmitter; and
responsive to the receiving the reflection of the radar signal, transmitting, to the radar-transmitter using the second resource grant, a radar measurement report message.

17. The method of claim 16, further comprising:
receiving, from the radar-transmitter, a radar capability enquiry; and
transmitting, to the radar-transmitter in response to the radar capability enquiry, a radar capability response that indicates radar capabilities supported by the radar-receiver for a bistatic radar sensing.

18. The method of claim 17, wherein the radar capability response comprises at least one indication of:
a radar waveform parameter indicating a radar waveform the radar-transmitter is capable of detecting;
a minimum radar range resolution capability of the radar-transmitter;
a minimum radar Doppler resolution;
a first minimum delay between a reception of the PDCCH grant by the radar-transmitter and a first time that the radar-transmitter is configured for the receiving the reflection; or
a second minimum delay between the reception of the PDCCH grant and a second time that the radar-transmitter is configured for the transmitting the measurement report message.

19. The method of claim 16, further comprising:
transmitting, to the radar-transmitter, a request message requesting the radar-transmitter to transmit object information after the radar-transmitter determines the object information from the radar measurement report message.

20. The method of claim 16, further comprising:
transmitting, to the radar-transmitter, a first message indicating that the radar-receiver is not available for the radar sensing assistance; and
in response to the transmitting the first message, receiving, from the radar-transmitter, a second message to disregard a radar assistance request.

21. The method of claim 20, wherein the transmitting the first message is caused by detecting a condition of the radar-receiver indicating the radar-receiver is not available for the radar sensing assistance.

22. The method of claim 21, wherein the condition of the radar-receiver is:
a temperature condition, or
a battery condition.

23. The method of claim 16, further comprising:
receiving, from the radar-transmitter prior to receiving the reflection, downlink control information (DCI), that indicates at least one indicator of:
a downlink frequency resource for the radar signal;
a downlink timing resource for the radar signal; or
a radar waveform.

24. The method of claim 23, wherein the DCI also indicates an uplink resource for the transmitting the radar measurement report message.

25. The method of claim 16, further comprising:
receiving, from the radar-transmitter, a configuration message that configures the radar-receiver to assist the radar-transmitter with bistatic radar sensing.

26. The method of claim 25, further comprising:
responsive to the receiving the configuration message, rejecting the configuration message with an indication that the radar-receiver will not perform the radar sensing assistance.

27. The method of claim 25, wherein the radar-receiver is one of a plurality of radar-receivers, and wherein the configuration message includes a group identifier (ID) for identifying the plurality of radar-receivers.

28. A method of radar sensing assistance at a radar-transmitter, comprising:
transmitting, to a radar-receiver, a radar sensing request message requesting the radar-receiver to assist the radar-transmitter with bistatic radar sensing;
responsive to the transmitting, receiving, from the radar-receiver, a physical downlink control channel (PDCCH) grant indicating radar transmission resources;
responsive to the receiving, transmitting a radar signal using the radar transmission resources and toward a region of interest; and
receiving, from the radar-receiver responsive to the transmitting the radar signal, a radar measurement report message.

29. The method of claim 28, further comprising:
receiving, from the radar-receiver, a radar capability enquiry; and
transmitting, to the radar-receiver in response to the radar capability enquiry, a radar capability response that indicates radar capabilities supported by the radar-transmitter for the bistatic radar sensing.

30. An apparatus for wireless communication at a radar-receiver, comprising:
a transceiver;
a memory; and
a processor coupled to the memory and the transceiver, the processor configured to:
transmit, to a radar-transmitter, a radar sensing request message for requesting radar sensing assistance;
receive, from the radar-transmitter, a physical downlink control channel (PDCCH) indication of a first resource grant for radar signal reception and a second resource grant for radar measurement report message transmission;
receive, using the first resource grant, a reflection of a radar signal transmitted by the radar-transmitter; and
responsive to receive the reflection of the radar signal, transmit, to the radar-transmitter using the second resource grant, a radar measurement report message.

31. The apparatus of claim 30, wherein the processor is further configured to:
receive, from the radar-transmitter, a radar capability enquiry; and
transmit, to the radar-transmitter in response to the radar capability enquiry, a radar capability response that indicates radar capabilities supported by the radar-receiver for a bistatic radar sensing.

32. The apparatus of claim 31, wherein the radar capability response comprises at least one indication of:
a radar waveform parameter indicating a radar waveform the radar-transmitter is capable detecting;
a minimum radar range resolution capability of the radar-transmitter;
a minimum radar Doppler resolution;
a first minimum delay between a reception of the PDCCH grant by the radar-transmitter and a first time that the radar-transmitter is configured for the receiving the reflection; or a second minimum delay between the reception of the PDCCH grant and a second time that the radar-transmitter is configured for the transmitting the measurement report message.

33. The apparatus of claim 30, wherein the processor is further configured to:
transmit, to the radar-transmitter, a request message requesting the radar-transmitter to transmit object information after the radar-transmitter determines the object information from the radar measurement report message.

34. The apparatus of claim 30, wherein the processor is further configured to:
transmit, to the radar-transmitter, a first message indicating that the radar-receiver is not available for the radar sensing assistance; and
in response to transmit the first message, receive, from the radar-transmitter, a second message to disregard a radar assistance request.

35. The apparatus of claim 34, wherein to transmit the first message is caused by when the processor is further configured to: detect a condition of the radar-receiver indicating the radar-receiver is not available for the radar sensing assistance.
